(19) United States
(12) Patent Application Publication
(10) Pub. No.: US 2011/0132172 A1
(43) Pub. Date: Jun. 9, 2011

(54) CONDUCTOR CENTRIC ELECTRONIC MUSIC STAND SYSTEM

(76) Inventor: Roland Raphael Guéneux, Wallisellen (CH)

(21) Appl. No.: 13/054,366

(22) PCT Filed: Jul. 15, 2008
(86) PCT No.: PCT/EP2008/059203

§ 371 Date: Feb. 22, 2011

(51) Int. Cl. G10G 7/00; G10G 7/02

(52) U.S. Cl. 84/454; 84/453

(57) ABSTRACT

The object of the invention is a conductor centric electronic music stand system (1) comprising a master electronic music stand (10) and one or more slave electronic music stands (50). An interactive user interface (100) for use in at 1 electronic music stand (10 or 50) and a computer-readable storage medium containing a set of instructions (SI) are also provided. The conductor centric electronic music stand system (I), the interactive user interface (100) and the computer-readable storage medium containing a set of instructions (SI). The instructions (SI) enable the transmission of annotations and or changes to the sheet music between the master electronic music stand (10) and slave electronic music stands (50); and to enable the master electronic music stand (10) to transmit sheet music retrieved from its storage medium (12) to one or more slave electronic music stands (50).

### FIELD OF THE INVENTION

The present invention relates to an electronic music stand system to be used either collaboratively by an orchestra and its conductor or by musicians alone.

### BACKGROUND OF THE INVENTION

A constant issue that orchestras and musicians have to face is the difficulty in use and handling of sheet music.

First of all, sheet music is difficult to handle during a performance where some musicians play long passages and flipping pages can prove to be difficult. Flipping of the page might even cause short interruptions which are undesired in a professional orchestra. In some cases assistants or players resting at the time assist another musician in flipping the page. Obviously none of these solutions is professional and comfortable enough to satisfy the need of world-class musicians.

To address this issue, several solutions have been developed in the past ranging from a mere mechanical page flipping mechanism to electronic solutions such as displays. However, all these devices focus purely on providing alternative manual means to be used by the musician for flipping the page of sheet music, usually by a foot pedal of some sort, but fail to address further disadvantages of paper printed sheet music.

A further drawback of paper based sheet music is the difficulty to produce sheet music for all instruments and to handle and distribute these. Each time a musical piece has to be written for each instrument, a great deal of effort has to be put into making all copies of different scores available for all musicians. It is quite often, that during rehearsals this process is repeated several times until the final copies are decided upon. Composers, conductors and musicians often collaboratively produce what is called the final score. It is then a clerk's job to gather and finalize all scores, i.e. the full score that the conductor has, the single instrument scores of musicians, the vocal scores of the singers, etc. During such a process it is always difficult to centralize the annotations/changes made in each score and to decide which annotation/change is to be kept. This process is especially common during rehearsals for a new premiere.

A few attempts have been made to address this issue by employing a collection of electronic music stands. However, these prior art systems merely replace the paper copies with displays in connection with software to display sheet music, but do not really provide the required support for a truly collaborative, conductor-centric sheet music production/use. It is also important to note that quite a few prior art solutions could not offer the much needed versatility to make them practical. For this reason very few systems have been adopted by musicians.

It is thus an object of the present invention to provide an alternative to classical paper-based sheet music that allows for a collaborative work in an orchestra of any size but in the same time suitable to be used by a single musician alone or by a group of musicians, such as a chamber orchestra, for instance.

It is a further objective of the present invention to provide a flexible, versatile and convenient solution that is suitable for different musical setups and that can be easily adopted by musicians.

It is a further objective of the present invention to provide a solution that provides an easy and fast support for exchange, storage and retrieval of sheet music.

The above objectives are solved by the present invention by providing a master electronic music stand connectable to a multitude of slave electronic music stands, wherein the master electronic music stand allows user using it (e.g. the conductor) to annotate and/or change the sheet music, transmit said annotations and/or changes to the sheet music to one or more of the connected slave music stands, save these annotations and/or changes to the sheet music onto a storage medium and to retrieve said saved annotations and/or changes to the sheet music from a storage medium.

The above objectives are further solved by a network comprising a master electronic music stand as described above and one or more slave electronic music stands, said network being configured to: connect the slave electronic music stands with the master electronic music stand; to enable a transmission of annotations and/or changes to the sheet music between the master electronic music stand and slave electronic music stands; and to enable the master electronic music stand to transmit sheet music retrieved from its storage medium to one or more slave electronic music stands.

These objectives are also solved by an interactive user interface for use in an electronic music stand, said interactive user interface comprising: an area for displaying sheet music; means for changing and/or annotating said sheet music; and means for interacting with a storage medium. The interactive user interface being characterized in that: said area for displaying sheet music is capable of simultaneously displaying a plurality of music scores which for instance correspond to different instruments; said means for interacting with a storage medium allows saving/retrieving of sheet music and of changes and/or annotations to/from said storage medium; said means for changing and/or annotating said sheet music providing the possibility of simultaneously changing and/or annotating a plurality of music scores. The interactive user interface preferably further comprises a video image area for displaying images received/broadcast by said electronic music stand; means for initiating a transfer of sheet music and of changes and/or annotations of the sheet music made to other electronic music stands; and means for initiating displaying of received sheet music and of changes and/or annotations of the sheet music from other electronic music stands.

The above objectives are further solved by a network comprising several (slave) electronic music stands, said network being configured to: connect the (slave) electronic music stands to enable them to exchange information; to enable a transmission of annotations and/or changes to the sheet music between the (slave) electronic music stands; and to enable the (slave) electronic music stands to cooperatively annotate and/or change the sheet music, and to store/retrieve sheet music from a storage medium.

A computer-readable storage medium is also developed to achieve the objects of the present invention, said medium containing a set of instructions that cause a computer to carry out the functions: of loading a plurality of music scores, which for instance correspond to different instruments, and accompanying annotations and/or changes from a storage medium; of controlling an interactive user interface to simultaneously display a plurality of music scores corresponding to different instruments; of controlling a communication port to transmit sheet music and changes and/or annotations of the sheet music made to other computers; of controlling the interactive user interface to display sheet music and of changes and/or annotations of the sheet music received through the communication port from other computers; of allowing a user of the interactive user interface to annotate and/or change sheet music displayed on it; and the function of allowing a user of the interactive user interface to save said annotations and/or changes to the sheet music onto the storage medium.

The most important advantage of the present invention is that it allows musicians to completely replace paper-based sheet music with a high-tech solution that offers the possibility of seamless collaborative work in an easy to manage, user-friendly environment. A further advantage of the present invention is that sheet music and scores for different instruments can be saved, retrieved, transmitted easily together with changes and/or annotations.

An advantage of the computer-readable storage medium containing a set of instructions is that it can be loaded on any standard of the shelf computing device without the need for specially built dedicated devices, thus permitting a serious cost saving in certain scenarios.

### BRIEF DESCRIPTION OF THE DRAWINGS

Further characteristics and advantages of the invention will in the following be described in detail by means of the description and by making reference to the drawings. Which show:

FIG. 1A schematic diagram of the hardware components of the conductor centric electronic music stand system according to the present invention;

FIG. 2A A structural diagram of a master electronic music stand according to the present invention;

FIG. 2B A schematic view of an electronic conducting baton according to the present invention;

FIG. 2C A structural view of a slave electronic music stand according to the present invention;

FIG. 3 A schematic overview of the conductor centric electronic music stand system showing an example of the interactive user interface in use, according to the present invention;

FIG. 4A An illustrative view of the interactive user interface according to the present invention;

FIG. 4B A further illustrative view of the interactive user interface according to the present invention, showing a so-called drag and drop feature of the interactive user interface;

FIG. 5 A further illustrative view of the interactive user interface according to the present invention, showing a so-called collapsed group of scores;

FIG. 6 A further illustrative view of the interactive user interface according to the present invention showing different overlays;

FIG. 7A An illustrative view of the interactive user interface according to the present invention showing a video window;

FIG. 7B An illustrative view of the interactive user showing a semitransparent video layer.

### DESCRIPTION OF PREFERRED EMBODIMENTS

The present description focuses on the conductor and on providing him/her the possibility to seamlessly collaborate with all musicians of an orchestra while making sure the maximum amount of time is spent with creative artistic work and the time needed to create, handle and distribute sheet music, its annotations and instructions is minimized. The same principle, however, also applies in a group of musicians, e.g. in a chamber orchestra, where the musicians cooperate during rehearsal, for instance.

For simplicity, in the context of the present invention, the term orchestra will be used to refer to any number of musicians playing a musical piece or composition. This term also includes solo musicians and groups ranging from small chamber music assemblies to philharmonic orchestras.

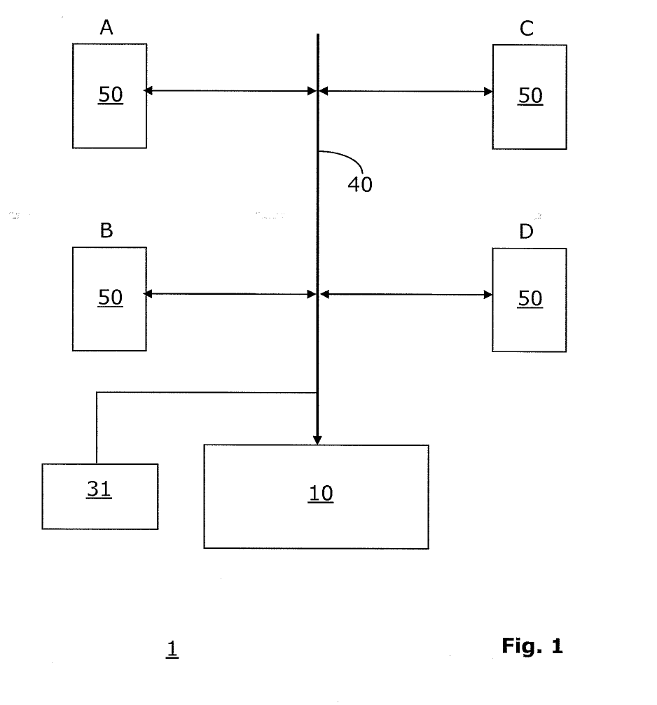

FIG. 1 shows a highly schematic diagram of the hardware components of the conductor centric electronic music stand system 1 according to the present invention. The main hardware components are thus: a master electronic music stand 10, at least one, but preferably more slave electronic music stands 50 connected by a communication network 40. The setup of the conductor centric electronic music stand system 1 is dedicated mostly to be used by an orchestra. This is a scenario where all the advanced features of the conductor centric electronic music stand system 1 can be put into use. However, even solo interprets, rehearsing musicians or conductors can benefit from a master electronic music stand 10 or a slave electronic music stand 50.

It is alsom possible to employ a number of identical music stands, where one music stand acts as master, or where music stands communicate, like in a group-ware environment where several users edit a common document, or the like.

The components of the network shown on FIG. 1 are connected by a communication network 40, which can be either a wired or a wireless communication network. Depending on the use of the conductor centric electronic music stand system 1, the communication network 40 is preferably a wireless communication network or a wired network. In mobile setups, where the arrangement of musicians varies often, a wireless network is preferred. To make use of commonly available communication hardware, the IEEE 802.11 standard, or commonly known as “WiFiff, is preferred, but Bluetooth, Infrared or even proprietary communication protocols may be used. In fixed installations, like in a concert hall or orchestra pit, where the arrangement of the musicians is relatively static, a wired network might be preferred. For the same reasons of using standardized hardware, the network of choice for a wired network is the IEEE 802.3 standard, or commonly known as “Ethernet”. Even if they are less flexible, it is known that wired networks do present a number of advantages over wireless networks. One of these advantages that might have a great importance during recordings of a performance is that a wired network does not create unnecessary noise in the radio spectrum, thus reducing the possibility of interference with other electronic systems. A further advantage of a wired network is that there is a possibility of powering all hardware via this same network, making the use of separate power cords unnecessary. Achieving this is especially practical when the Ethernet standard network is used, since a dedicated standard already exists for powering devices over Ethernet, called “Power over Ethernet” or also known as PoE. Powering all devices by the communication network 40 directly has the main advantage that the conductor centric electronic music stand system 1 is a completely integrated system and the entire system can be centrally managed, including the power supply for each piece of hardware. This can be of great importance in setups where power supply is not stable enough for some reason. If needed, the network can be provided with an Uninterruptible power supply 31 or UPS, thus making the conductor centric electronic music stand system 1 robust against power failures, allowing the musicians to continue their work undisturbed.

It is to be observed, that the particular choice of communication standard does not affect the general inventive concept of the invention, and any particular choice should not be considered as a limitation of the scope of the invention.

Even though the network shown on FIG. 1 is a bus topology network, it is to be noted that the topology of the communication network 40 can vary from star to ring or mesh without affecting its basic function, .e. exchange of data between hardware components of the conductor centric electronic music stand system 1.

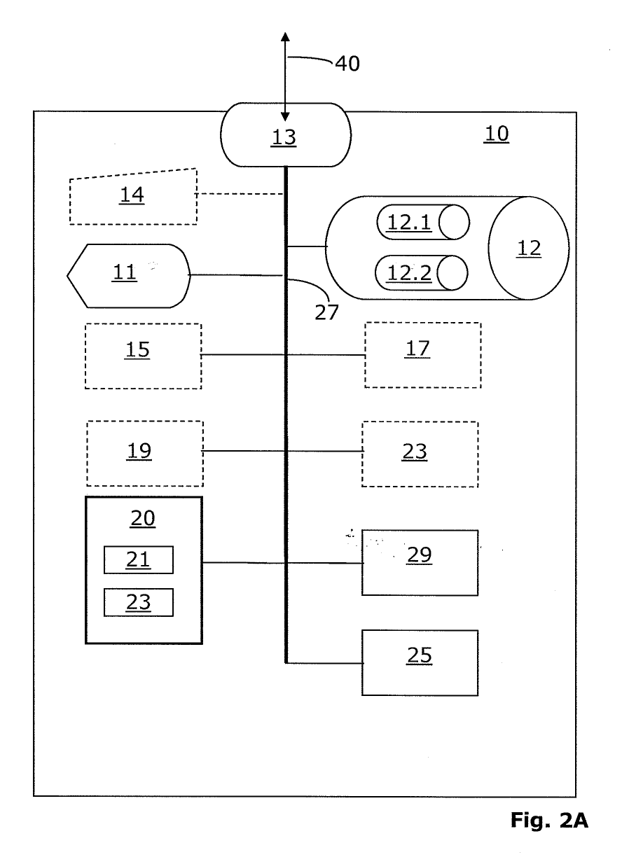

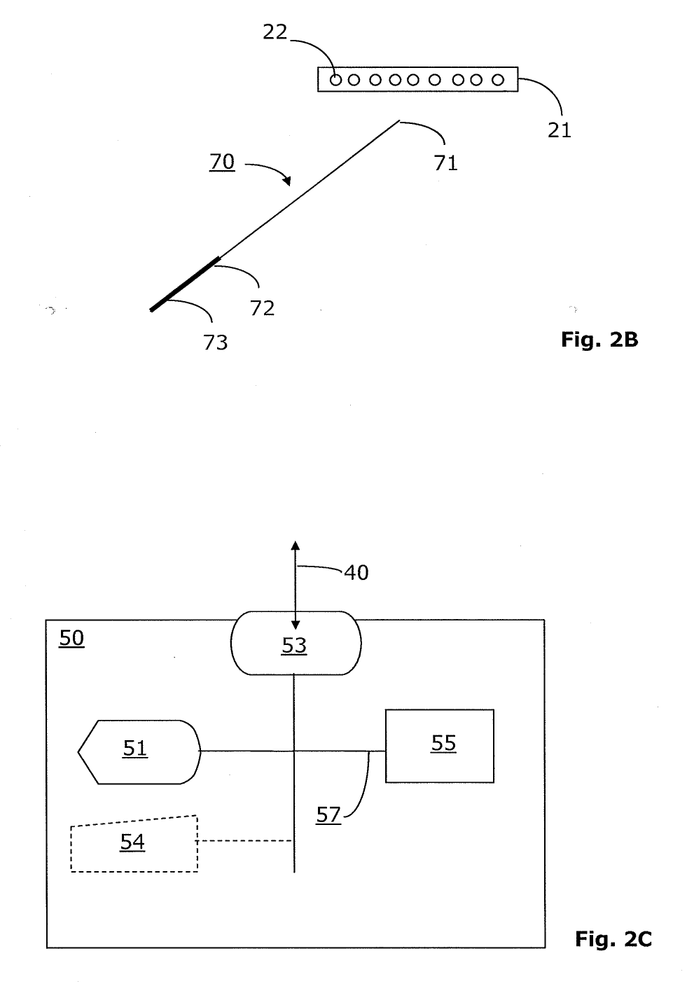

FIG. 2A shows a structural view of a master electronic music stand 10 according to the present invention. The master electronic music stand 10 has a central role in the conductor centric electronic music stand system 1 and in the management of the communication network 40 as shown on FIG. 1. The master electronic music stand 10 can also be viewed as a server in the communication network 40 and the multiple slave electronic music stands 50 as client stations. However, in certain deployments an equal role can be assigned to all components of the conductor centric electronic music stand system 1.

It can be seen on FIG. 2A that all hardware components of the master electronic music stand 10 are connected by a bus 27. This is the preferred way of connection and it is also the established standard for most of the available computing devices. The capacity of the bus 27 is designed so that the communication between the hardware components is quick and error-free. A bus 27 is also preferred because a bus system usually allows the connection of additional hardware at any time. However, different ways of connecting the components described in the coming paragraphs is also possible.

An essential component of each master electronic music stand 10 is the central processing unit or CPU 25. This CPU 25 is capable of carrying out a sequence of instructions according to a set of instructions SI. The CPU 25 of the preferred embodiment is directly connected to the bus 27 and also manages all traffic on said bus 27. The CPU 25 of the master electronic music stand 10 can be a dedicated CPU specially designed for the purpose of the present invention, or it can be a general-purpose processor similar to those found in common computing devices. The term CPU is used in this context as a general term and includes all additional components that a processor is fitted with, like buffers, cash registers, clock generators (usually a quartz crystal) etc. Preferred are low energy consumption integrated CPU's.

As shown on FIG. 2A, the master electronic music stand 10 comprises a communication port 13, which is used to connect to the communication network 40 described above. Depending on the technology chosen for the communication network 40, the communication port 13 can be a wireless module, a wired network adapter, etc. To make use of widely available hardware, standard communication port 13 are preferred, like an IEEE 802.11 (WiFi) access card or an IEEE 802.3 (Ethernet) network adapter. In case of the powered wired network described above, the communication port 13 is a “Power over Ethernet” or PoE-enabled network adapter, being capable of powering the entire master electronic music stand 10. By using a PoE-enabled communication port 13, in case of a power failure, the master electronic music stand 10 can be powered via the communication network 40 by the UPS 31 (cf. FIG. 1) connected to the communication network 40.

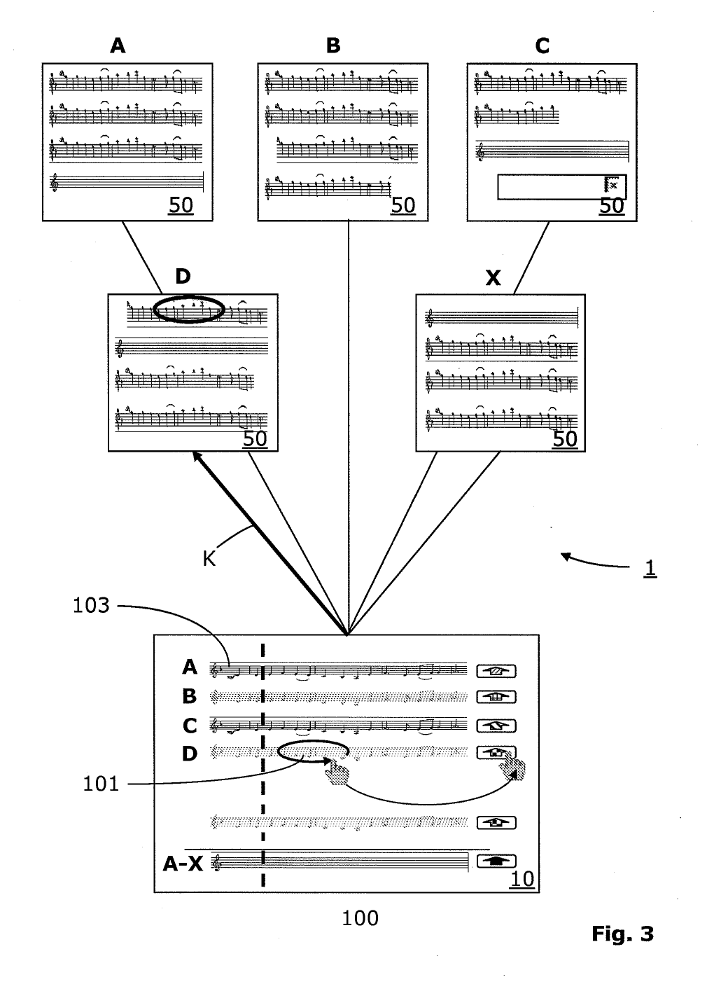

The master electronic music stand 10 further comprises a display 11 used for displaying an interactive user interface 100 showing sheet music, annotations, etc. This interactive user interface 100 will be described in detail in relation with FIGS. 3 to 7B which show possible layouts of the interactive user interface 100. Preferably this display 11 is a touch-sensitive panel capable of displaying high resolution images, thus allowing an artist to easily read sheet music on the display 11 and interact with the interactive user interface 100 via the touch-sensitive panel. Being used for reading sheet music, the display 11 should also preferably have a high contrast ratio, so that it can be read in various lighting conditions, ranging from a brightly-lit open-air performance to a relatively dark orchestra pit during a theatrical play. In case the display 11 is touch-sensitive, a fingerprint and grease resistant coating of the display 11 is also preferred to reduce the amount of marks on the display 11. In case of mobile deployment, an energy-efficient low consumption panel is preferred.

If the display 11 is not a touch-sensitive display panel, then the display 11 is accompanied by an additional pointing and input device 14. This allows the user to interact with the interactive user interface 100 in the absence of the touch-sensitive panel of the display 11. This pointing and input device 14 can be a computer mouse, an optical pen, a keyboard, a trackball or a combination of these.

It is to be noted, that the advanced features enlisted above merely make the display 11 more appealing, but even the simplest display can substitute a more advanced one as long as it is capable of displaying the interactive user interface 100, even if in lower level of detail.

A storage medium 12 of some sort is also an essential element of the master electronic music stand 10. It is the main role of the storage medium 12 to store sheet music, its multiple versions, changes and annotations. The storage medium 12 is also capable of storing user preferences and various settings of the interactive user interface 100. In a preferred embodiment of the present invention, the storage medium 12 consists of actually two parts, a fixed storage medium 12.1 and a removable storage medium 12.2.

The fixed storage medium 12.1 is meant to store the set of instructions SI that controls the master electronic music stand 10 and actually the entire conductor centric electronic music stand system 1 to perform its tasks. This set of instructions SI is also known in the art as firmware, meaning the set of instructions pre-programmed to allow a device to perform its intended functions. In a preferred embodiment, this set of instructions SI is upgradeable, should a bug be later identified or to allow new features to be implemented without the need to change the hardware setup.

The removable storage medium 12.2 on the other hand is meant to store so-called dynamic data, i.e. user settings and user data. User settings is used here as a common term for preferences set for the device, interactive user interface 100, authentication data used by the communication port 13 etc. User data means, in the context of the present application, all sheet music data with all its versions and annotations. This includes all the scores like for example the full score used by the conductor, the vocal score for singers, the instrument scores used by a single musician, etc. In the preferred embodiment, each of these scores can be accompanied

by a set of annotations and remarks specific to a single score, to a group of scores or to the full score, i.e. available for all artists within the orchestra. This removable storage medium 12.2 can then be removed from the master electronic music stand 10 and later inserted into the same master electronic music stand 10 or into a compatible device in order to retrieve the saved user data. The removable storage medium 12.2 may use semiconductor based, magnetic or optical storage. However, one should note that the particular choice does not alter the basic function, the removable storage medium 12.2 fulfills, i.e. storing user data. In the preferred embodiment, the removable storage medium 12.2 is a NAND-type flash memory data storage device integrated with a USB (universal serial bus) connector or commonly known as a USB flash drive. The main advantage is that standard, highly available and reliable hardware can be used and that most modern computing devices are capable of reading these. The capacity of the removable storage medium 12.2 is chosen so that it is sufficient for a large quantity of user data.

An optional component of the master electronic music stand 10 is the metronome 15. This produces a regulated audible, visual, touch or any combination of the three, pulse. This helps musicians to establish a steady tempo, measured in beats-per-minute (BPM) for the performance of musical compositions. The master electronic music stand 10 of the present invention preferably comprises an electronic metronome 15 with a quartz crystal to maintain accuracy. In the preferred embodiment of the metronome 15, a regular “tick” sound indicates the beat within each measure, and another, distinct sound indicates the beginning of each measure. This is known as a dual metronome. A tempo control adjusts the amount of time separating each beat (typically measured in beats per minute), while another, discrete, control adjusts the meter of the rhythm and thus the number of beats in each measure.

The master electronic music stand 10 according to the present invention also features an optional microphone 19. This can serve multiple purposes like detecting the pitch or beat of an instrument close to the music stand. The microphone 19 can be thus used to automatically detect the BPM or beat per minute of the musical piece being played by taking up acoustic signals. The use of this BPM detection will be described later in relation to figures describing the interactive user interface 100. In certain embodiments of the present invention, the microphone 19 can be implemented as a collection of several microphones placed at several locations around the orchestra to equally capture sounds from all instruments or groups of instruments.

A further optional component of the master electronic music stand 10 is the tuning pipe 17. This helps musicians find the correct pitch and correctly tune their instruments. A musician plays a note, and an indicator on the display 11 tells the musician whether the pitch of that note is lower, higher, or approximately equal to the desired pitch. The tuning pipe 17 of the preferred embodiment additionally attempts to automatically detect which pitch is intended or in an alternative embodiment require the musician to specify the target pitch. It is to be noted that the tuning pipe 17 might use the microphone 19 described above or it may feature a separate dedicated microphone.

The preferred master electronic music stand 10 of the present invention further comprises the optional electronic conducting baton 70. The electronic conducting baton 70 preferably has the exact shape and weight of a classical conducting baton used by conductors. However, the electronic conducting baton 70 is capable of providing signals in response to movements of said electronic conducting baton 70. The movement of the electronic conducting baton 70 is recorded by means of an arrangement of an accelerometer 73 and a sensor 71. Preferably, a three-axis accelerometer is being used, capable of detecting movement along all three axis of the Cartesian coordinate system. The sensor 71 is used to detect where the electronic conducting baton 70 is pointing at. The sensor 71 works in conjunction with means for detecting movements of a conducting baton 70 which in the preferred embodiment comprises a so-called sensor bar 21. The sensor bar 21 comprises a series of identifying emitters 22, preferably infrared-LED'S.

The principle of detecting where the electronic conducting baton 70 is pointing at and its movements is as follows: the identifying emitters 22 of the sensor bar 21 constantly emit identifying signals in the direction of the electronic conducting baton 70; the sensor 71 of the electronic conducting baton 70 detects signals emitted by the identifier emitters of the sensor bar 21; the accelerometer 73 detects movements of the electronic conducting baton 70 in all three axis of the Cartesian coordinate system; the transmitter 72 of the electronic conducting baton 70 transmits the signals received from the sensor 71 and the accelerometer 73; the signals transmitted by the transmitter 72 are received by the receiver 23 (cf. FIG. 2A) of the means for detecting movements of a conducting baton 70 and sent for processing by the CPU 25 via the bus 27; based on the signals received, the CPU 25 calculates the exact position (by a process commonly known as triangulation) and movement of the electronic conducting baton 70.

The use of the detected motion, position and orientation of the electronic conducting baton 70 will be described in further paragraphs in relation with the interactive user interface 100.

In an alternative embodiment, the electronic conducting baton 70 comprises a light emitting element (e.g. an LED). This light emitting element is preferably positioned at one end of the conducting baton 70 in order for it to be visible. A CCD camera or another light sensitive system is placed at a certain distance of the location where the conductor is going to use the conducting baton 70. The CCD camera or other light sensitive system is facing the conductor and the conducting baton 70. The conducting baton 70 constantly emits light at a certain frequency. This light is seen as a spot by the CCD camera or other light sensitive system. Any 3-dimensional movement of the conducting baton 70 is transformed into a 2-dimensional representation.

In yet another embodiment, which is based on the embodiment just described, the conducting baton 70 also comprises an accelerometer 73, like the one described above. The accelerometer 73 provides a series of signals which are employed in order to trigger or control the light emitting element of the baton 70. Any deceleration or acceleration, for instance, which reaches a certain threshold could be “translated” into an on-off modulation of the light emitting element. The CCD camera or other light sensitive system in this case not only detects the movements of the baton 70, but it also receives additional information about the dynamics of the movement of the baton 70. As described in relation to previous embodiments of the conducting baton 70, these detected movements can also be interpreted and transmitted to other (e.g., slave) electronic music stands 50.

FIG. 2C depicts a slave electronic music stand 50 according to the present invention. The essential elements of the slave electronic music stand 50 are similar to those found in the master electronic music stand 10. Thus, the slave electronic music stand 50 comprises a communication port 53 which is compatible with the communication network 40 being used and is capable to transmit/receive data over the communication network 40 to/from the communication port 13 of the master electronic music stand 10. As with the communication port 13 of the master electronic music stand 10, the communication port 53 of the slave electronic music stand 50 can be of various types according to the technology used for the communication network 40, i.e. it can be a wired or wireless network adapter as already described in relation with the communication port 13 of the master electronic music stand 10. Furthermore, in a further embodiment of the present invention, a combination of technologies can also be used for the communication network 40, i.e. some of the slave electronic music stands 50 or the master electronic music stand 10 could be connected by a wireless connection while the others through a wired connection. This is called a hybrid network and is currently widely used within common networks such as local area networks LANs or wide area networks WANs.

The electronic music stand 50 may comprise a storage medium 12, like the one decicted in FIG. 2A.

The slave electronic music stand 50 further comprises a display 51 used for displaying an interactive user interface 100 showing sheet music, annotations, etc. Preferably this display 51 is a touch-sensitive panel capable of displaying high resolution images, thus allowing an artist to easily read sheet music of the display 51 and interact with the interactive user interface 100 via the touch-sensitive panel. Being used for reading sheet music, the display 51 should also preferably have a high contrast ratio, so that it can be read in various lighting conditions, ranging from a brightly-lit open-air performance to a relatively dark orchestra pit during a theatrical play.

If the display 51 is not a touch-sensitive display panel, then the display 51 is accompanied by an additional pointing and input device 54. This allows the user to interact with the interactive user interface 100 in the absence of the touch-sensitive panel of the display 51. This pointing and input device 54 can be a computer mouse, an optical pen, a keyboard, a trackball or a combination of these.

Similar to the master electronic music stand 10, all components of the slave electronic music stand 50 are preferably connected to a common bus 57.

An essential component of each slave electronic music stand 50 is the central processing unit or CPU 55. This CPU 55 is capable of carrying out a sequence of instructions according to a set of instructions SI. The CPU 55 of the preferred embodiment is directly connected to the bus 57 and also manages all traffic on said bus 57. The CPU 55 of the slave electronic music stand 50 can be a dedicated CPU specially designed for the purpose of the present invention, or it can be a general-purpose processor similar to those found in common computing devices.

It is to be noted, that the components of the slave electronic music stand 50 enlisted in the previous paragraphs are the minimum requirements of said slave electronic music stand 50 and that in further embodiments, a slave electronic music stand 50 can additionally comprise any component of a master electronic music stand 10 as described in relation to the master electronic music stand 10. A slave electronic music stand 50 is however configured to act as a slave station in the communication network 40, i.e. all slave electronic music stands 50 will be under the control of the master electronic music stand 10. The term control should be interpreted in its broadest meaning, i.e. each slave electronic music stand 50 receives instructions from a master electronic music stand 10 or is driven by it, etc. The level of independence of each slave electronic music stand 50 from the master electronic music stand 10 is configurable using the interactive user interface 100 and is set to meet the demands of the particular orchestra.

There are also configurations or constellations possible where all music stands have an identical setup. In this case one music stand may be elected to act as master, or all music stands cooperate following a groupware approach.

FIG. 3 shows a schematic overview of the conductor centric electronic music stand system 1 showing an example of the interactive user interface 100 in use. On this figure, each slave electronic music stand 50 and the master electronic music stand 10 are represented by a schematized view of the interactive user interface 100 displayed on them. Since FIG. 3 is a functional diagram, the physical layout of the communication network 40 and of the conductor centric electronic music stand system 1 can be different without affecting though its functionality.

The use of the conductor centric electronic music stand system 1 via the interactive user interface 100 is shown here in an abstract way. The depicted example shows how the interactive user interface 100 is displayed on displays 51 (FIG. 2C) and on the display 11 (FIG. 2A), showing here a different score for each artist A, B, C, D . . . X. The user controlling the master electronic music stand 10 annotates on its own display lithe music score of artist D and transmits said annotations to the slave electronic music stand 50 of artist D. In exactly the same manner, changes of notes can also be made on the interactive user interface 100 and transmitted over the communication network 40 to one, all or a group of slave electronic music stands 50. The bold arrow K on FIG. 3 illustrates the transmittal of an annotation 101 for the score 103 for artist D from the interactive user interface 100 of the master electronic music stand 10 to the interactive user interface 100 of the slave electronic music stand 50 for artist D via the communication network 40.

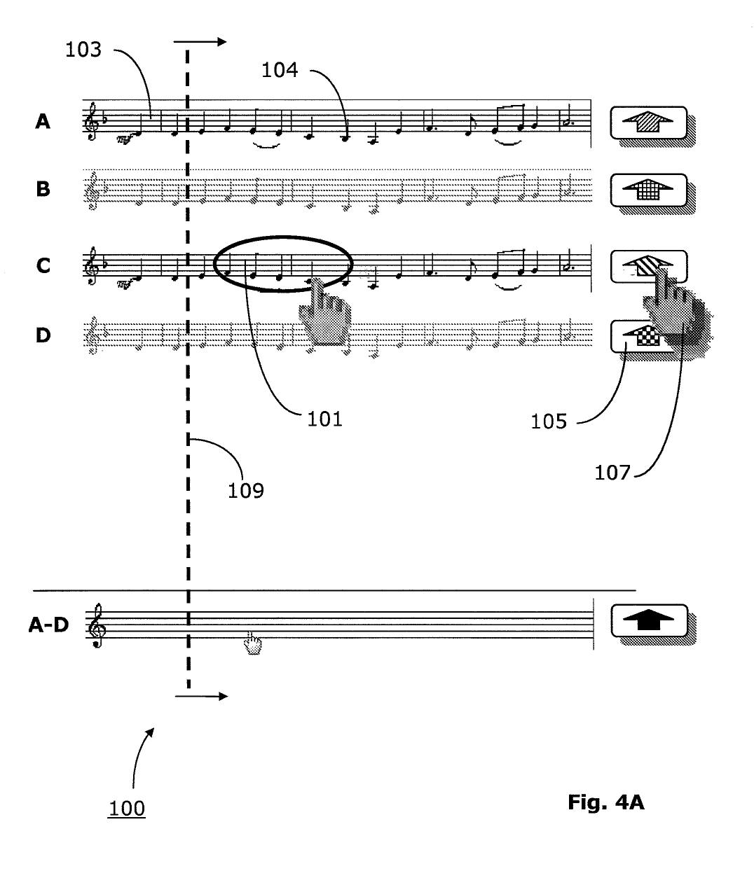

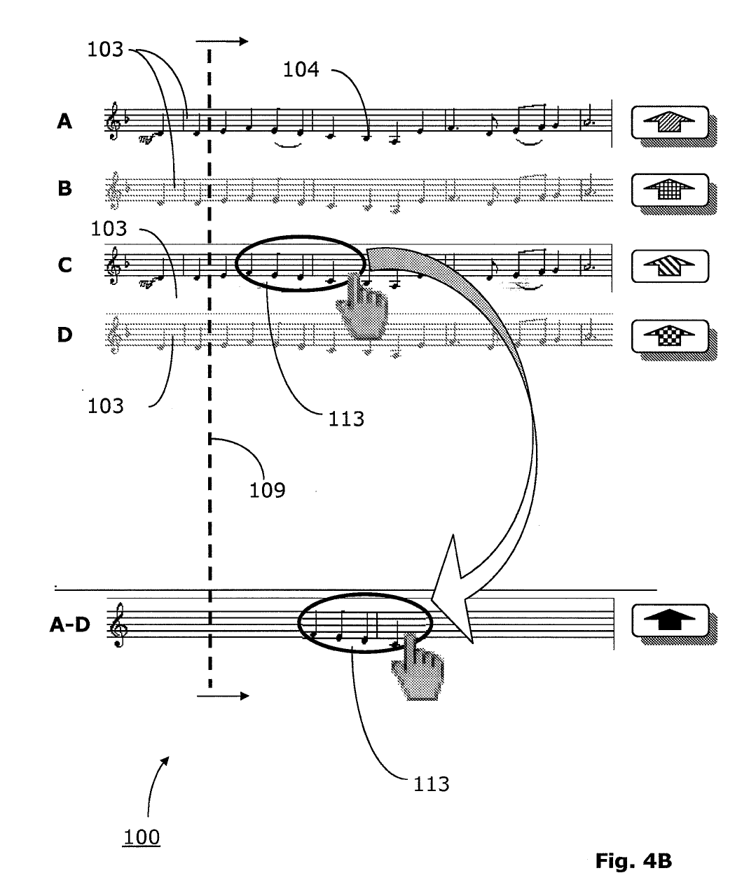

A detailed view of an exemplary embodiment of the interactive user interface 100 is shown on FIG. 4A. One should note however that according to settings and user preference the interactive user interface 100 can take up many different layouts, either pre-programmed ones or user created layouts. These layouts can be customized by a user and stored/retrieved from the storage medium 12. The example on FIG. 4A shows the interactive user interface 100 as configured for a conductor of an orchestra.

As a classical paper sheet music of an artist, the interactive user interface 100 is also dominated by musical notes 104. The conductor's full score is shown here with particular scores 103 for each artist or group of artists. An optional score 103 for a group of artists A-D is also provided, which aids the conductor to make changes, annotations that can be easily sent to this group of artists A-D rather than making said changes, annotations for each artist separately. In some cases, as the one shown here, this additional score 103 is an empty score, where the conductor can insert additional notes or just remarks for this group A-D of artist.

In a preferred embodiment of the invention, the conductor or user of a music stand is able to make annotations not only on and inbetween the lines of a score, but also above and below the scores. This may be necessary, since some annotations (e.g. an arrow being interpreted as a Crescendo) are typically put underneath a score and some annotations (e.g. a accent) are typically positioned above a score.

In yet another embodiment, the space between scores is typically kept as small as possible in order to be able to display as many scores on one screen as possible. If the conductor or user of a music stand wants to make annotation in the space between scores (this is above or below a certain score, as described above), a command (e.g. a double click) switches the display to an enlarged or widened presentation mode. In this mode there is ample room above and below in order to add annotations of any kind. Following another command (e.g. a double click), the display returns to a normal mode, where the spaces between the scores are compressed. During the process od compression the annotations are preferably translated or transformed in a manner that they are still properly visible.

Preferably each score 103 is provided with a dedicated collaboration button 105 used to transmit changes and/or annotations of that particular score 103 to the slave electronic music stand 50 or group of slave electronic music stands 50 associated with that score 103 or group of scores 103.

FIG. 4A also shows the selection pointer 107 which is used by the user of the interactive user interface 100 to perform various tasks. If the display 11 or display 51 is a touch-sensitive panel, then the selection pointer 107 is a virtual pointer that can not be seen and it is activated by the touch of the display 11 or display 51 by a finger of the user or of a stylus instrument designed for this purpose. In case of a display 11 or display 51 without a touch-sensitive feature, the selection pointer 107 is controlled using the pointing and input device 14 or 54.

FIG. 4B shows a so-called “drag and drop” feature of the interactive user interface 100 where a user can simply “drag” a selection of musical notes 113 and “drop” said selection of musical notes 113 into a different score 103 or into a different area of the same score 103. This feature greatly eases the handling of musical notes especially for composers or for the rearrangement of music.

FIGS. 4A and 4B also show a progress bar 109 which, based on the BPM detection described before, is able to automatically follow the musical piece being played on the sheet music, thus aiding artists in locating the current notes being played. This progress bar 109 may also be manually adjusted or shifted by the user of the master electronic music stand 10. The BPM detection mechanism/algorithm may be implemented so that an average value of several instruments is generated. This average value then causes the progress bar 109 to move forward at an average speed. $

In yet another embodiment, each music stand may offer a feature where a local BPM detection mechanism/algorithm detects the velocity of the local instrument and where on the local music stands display an indication is provided showing whether the local instrument is to slow

i.e. the local BPM is behind the average BMP), or where an indication is provided showing whether the local instrument is to quick (i.e. the local BPM is ahead of the average BMP). This feature can be switched on and off.

In the preferred embodiment of the present invention, this progress bar 109 is combined with an automatic page flipping feature, which is capable of automatically turning the sheet music to the next page as soon as the progress bar 109 reaches the end of a page. An advanced automatic page flipping feature will additionally show the artist a preview of the upcoming page of the sheet music even before the progress bar 109 reaches the end of the current page, thus ensuring that not a single musical note 104 is missed by the artist.

If no microphone 19 is provided or for some reason the artist turns off the automatic page flipping feature, means for manually controlling a flow of sheet music 18 is used instead. This is preferably a foot pedal with a number of switches used to turn the sheet music pages back and forward. It is also possible to attach a small remote control to the instrument at a location where it can be easily reached. Using this remote control, the page flipping can be controlled in this alternative embodiment.

In a further embodiment, the detected motion, position and orientation of the electronic conducting baton 70 is also used to detect the current position in the sheet music of the musical piece being played to assist the automatic page flipping feature.

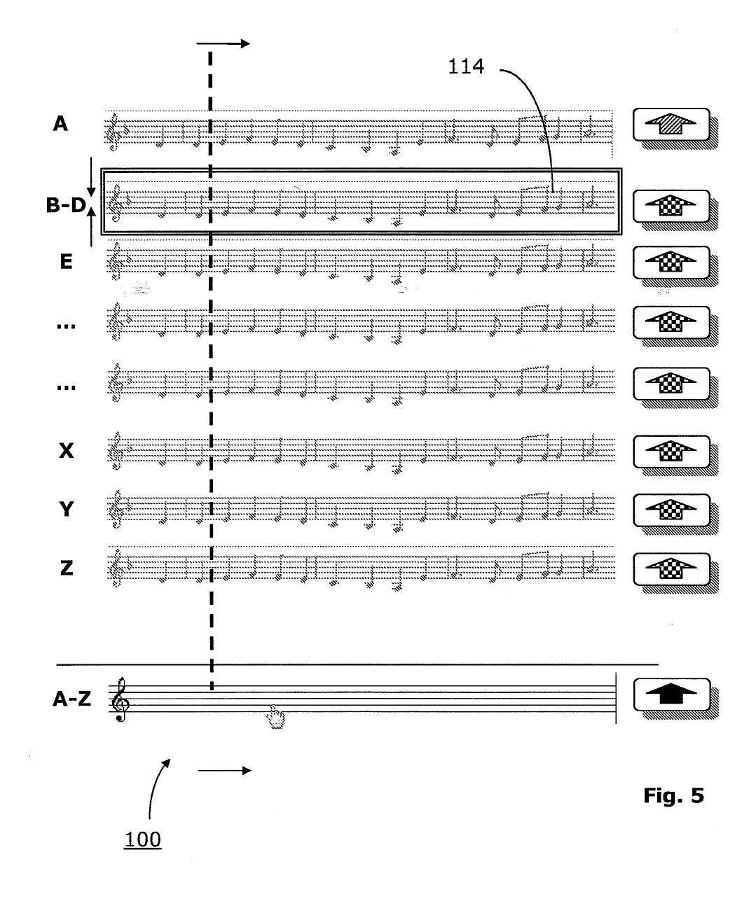

FIG. 5 shows a further feature of the interactive user interface 100, i.e. the collapsible scores. This feature comes handy when the full score of a conductor contains a large number of single instrument scores 103. In this case, the interactive user interface 100 on the display 11 of the master electronic music stand 10 might become overcrowded. To overcome this, the scores 103 for single instruments may be grouped together and “collapsed” into a single line to save space on the interactive user interface 100. This collapsed group of scores 114 can then be “expanded” again to reveal the containing scores if needed. Just as an example, in a large orchestra, the high number of scores for each instruments could be grouped into a small number of collapsed group of scores 114 by the type of instruments, like a collapsed group of scores 114 for woodwinds, a separate collapsed group of scores 114 for brass, an even further group for the percussion instruments and so on. This will help the conductor to manage scores for these groups of instruments much easier. It is to be noted that all these tasks can be carried out by a user of the interactive user interface 100 and that all these groups can be saved/retrieved at any time to/from the storage medium 12, these being part of the user data described earlier.

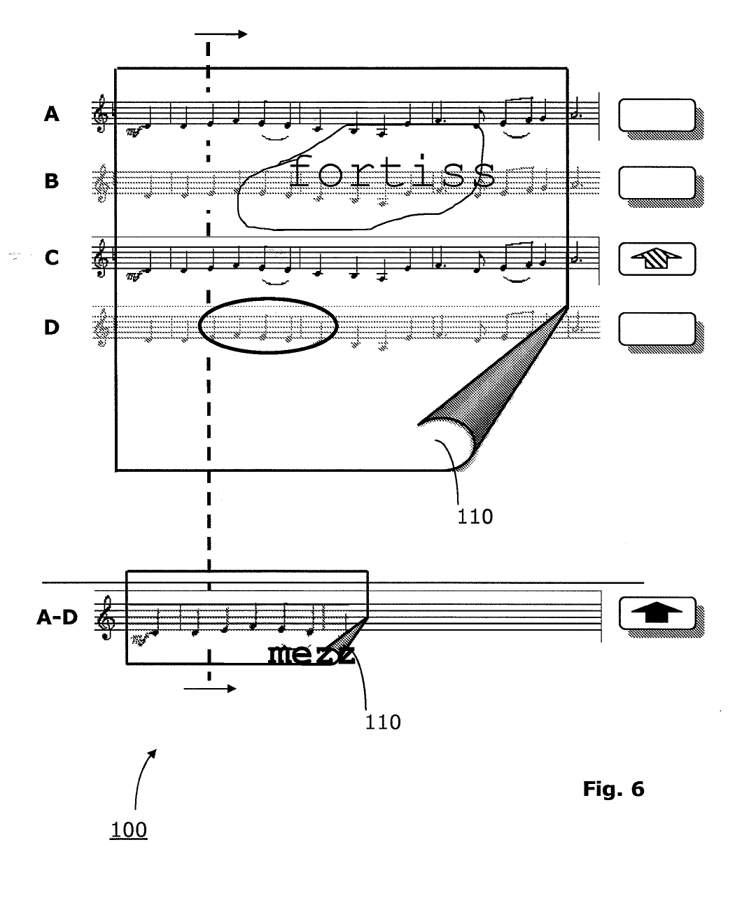

FIG. 6 shows a particular embodiment of the interactive user interface 100, where the annotations of the user are arranged on an independent overlay 110. This overlay 110 is presented as a semi-transparent layer above the sheet music and it is also interpreted independently, i.e. it can be saved/retrieved or transmitted/received independently from the sheet music. One should note, that the page curl on the lower right hand side of the overlay 110 is only meant to illustrate that the overlay 110 is separate layer on the interactive user interface 100 which can be removed at choice, and that this page curl illustration should not be interpreted that this overlay 110 is a physical layer on top of the display 11 or display 51, like tracing paper for example.

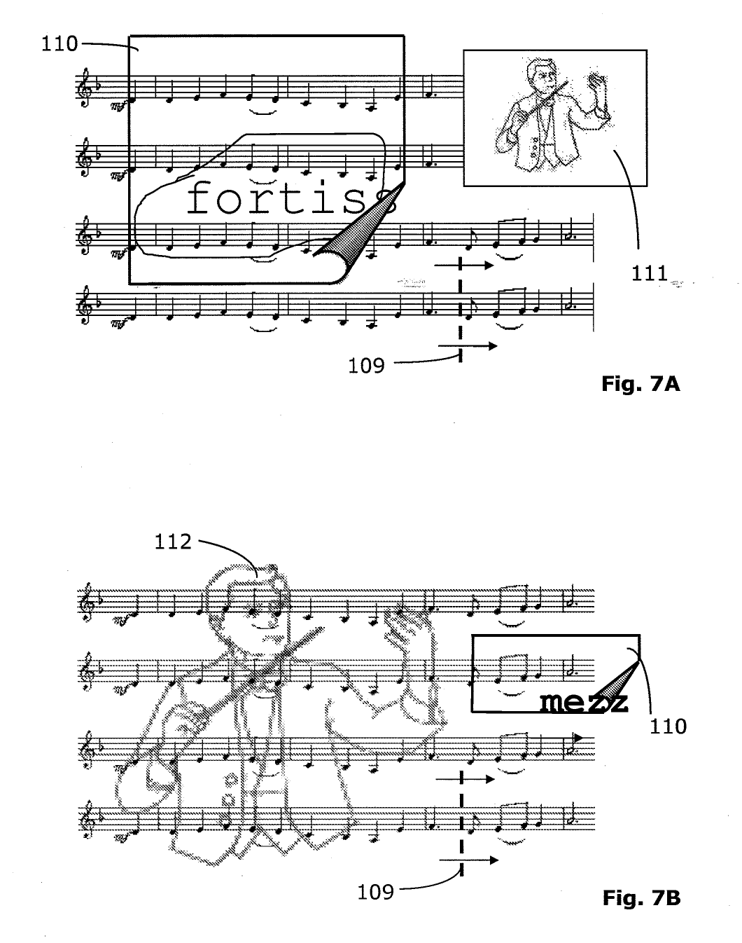

As shown on this figure, several different overlays 110 of different sizes and purposes can be defined on a single interactive user interface 100. Later on, each overlay 110 can be handled individually or together depending on the needs of the user. As it can be seen on FIGS. 7A and 7B, these overlays 110 can be then transmitted to/received by slave electronic music stands 50.

Such an embodiment of the interactive user interface 100 with independent overlays 110 has the advantage that the original sheet music always stays clean of any changes and different overlays 110 can be applied, added, changed or deleted without ever affecting the original sheet music.

A special optional feature of the conductor centric electronic music stand system 1 is shown on FIGS. 7A and 7B, i.e. the possibility of showing a live video broadcast of the conductor directly on the interactive user interface 100. The live video broadcast of the conductor is made possible by means of the video camera 29 of the master electronic music stand 10 as already described. This feature is very useful for several reasons: in some orchestra pits direct view of the conductor by some artists is not possible; musicians do not have to take their eyes of the sheet music anymore; musicians could play a single musical piece while being physically in different locations. This latest aspect is a revolutionary capability of the conductor centric electronic music stand system 1, providing the possibility to perform or rehearse a musical piece by an orchestra whose artists are at different locations, with the only requirement that each has a master electronic music stand 10 or slave electronic music stand 50 and that each has a connection to the communication network 40. This latest requirement can be easily solved by connecting the master electronic music stand 10 and the slave electronic music stands 50 over the internet as a communication network 40.

FIGS. 7A and 7B show different versions of the interactive user interface 100 with the live video broadcast. FIG. 7A shows an interactive user interface 100 with a dedicated video window 111 showing the image of the conductor. FIG. 7B, on the other hand, shows an interactive user interface 100 with a semitransparent video layer 112 serving the same purpose.

In a further embodiment, the detected motion, position and orientation of the electronic conducting baton 70, as described in previous paragraphs, is interpreted by the master electronic music stand 10 and transmitted to each slave electronic music stand 50. In this case the video window 111 or the semitransparent video layer 112 can display only an abstract representation of the movements of the conducting baton without showing the conductor himself, or a combination of these. In an even further embodiment, the detected motion, position and orientation of the electronic conducting baton 70 is additionally used to detect additional information that can be transmitted to each slave electronic music stand 50.

In a further embodiment of the present invention, the interactive user interface 100 has two modes of operation: an orchestra mode of operation and a solo mode of operation.

The orchestra mode of operation is optimized to be used collaboratively by an orchestra. This mode of operation is mostly used by the conductor of the orchestra and provides the advanced features of changing or annotating the sheet music and of transmitting these changes and annotations. This mode of operation is similar to the interactive user interface 100 as described earlier in relation to FIGS. 4 to 6.

The solo mode of operation of the interactive user interface 100 is designed for solo artists and is a simplified interactive user interface 100 mainly providing only the feature of displaying sheet music and of eventually of the progress bar 109. In a further embodiment, if the device, on which the interactive user interface 100 in the solo mode of operation runs on, is provided with a microphone, the solo mode of operation further comprises the automatic page flipping feature as described in previous paragraphs. This mode of operation is similar to the interactive user interface 100 as described earlier in relation to FIGS. 7A and 7B.

In a further embodiment of the present invention, the entire conductor centric electronic music stand system 1 is achieved by a computer-readable storage medium containing a set of instructions SI that cause a computer to carry out the functions of the conductor centric electronic music stand system 1.

A special optional feature of the present invention is a baton 70 which can be used as baton and as pointing device for activating/manipulating the touch screen. In this case the baton 70 preferably is a telescopic baton.

Among others, as described throughout the specification, these 30 functions include:
loading a plurality of music scores corresponding to different instruments and accompanying annotations and/or changes from a storage medium 12;
controlling the interactive user interface 100 to simultaneously display a plurality of music scores corresponding to different instruments;
controlling the communication port 13 to transmit sheet music and changes and/or annotations of the sheet music made to other computers;
controlling the interactive user interface 100 to display sheet music and of changes and/or annotations of the sheet music received through the communication port 13 from other computers;
allowing a user of the interactive user interface 100 to annotate and/or change sheet music displayed on it; allowing a user of the interactive user interface 100 to save said annotations and/or changes to the sheet music onto the storage medium 12.

The set of instructions SI according to the present invention is designed to be executable on standard, so-called of the shelf computing devices such as laptops, tablet pc's or personal digital assistants or PDAs.

It is to be noted, that as long as these standard computing devices comprise the essential components as described in previous paragraphs in relation to the master electronic music stand 10 or the slave electronic music stand 50, the set of instructions SI is capable of providing the same features as the conductor centric electronic music stand system 1 with custom-designed master electronic music stand 10 and slave electronic music stands 50.

The main advantage of this embodiment is the possibility of using highly available, of the shelf hardware to build the conductor centric electronic music stand system 1, which might lead to cost and time savings.

In a further embodiment of the present invention, the conductor centric electronic music stand system 1 offers two modes of operation. In a first mode of operation (called rehearsal mode), the conductor and the musicians can co-operate, as described before. In a second mode of operation (called live mode), any of the features which are only useful during rehearsals are switched off or deactivated.

It will be understood that many variations could be adopted based on the specific structure hereinbefore described without departing from the scope of the invention as defined in the following claims.

1. Electronic music stand (10) with
a display (11) for displaying an interactive user interface showing sheet music and annotations,
a storage medium (12) for storing sheet music and annotations,
a communication port (13) for connecting at least one other electronic music stand (50),
characterized in that:
the electronic music stand (10) provides the user the possibility to:
annotate and/or change the sheet music via the interactive user interface (100);
transmit said annotations and/or changes to the sheet music via the communication port (13) to one or more of the connected other electronic music stands (50);
save said annotations and/or changes to the sheet music onto the storage medium (12);
retrieve said saved annotations and/or changes to the sheet music from the storage medium (12).

2. Electronic music stand (10) according to claim 1, characterized in that it further comprises:
a metronome (15) for precise beat indication.

3. Electronic music stand (10) according to claim 1, characterized in that it further comprises:
a tuning pipe (17) for tuning of instruments.

4. Electronic music stand according to claim 1, characterized in that it further comprises:
a microphone (19) for precise tempo detection, wherein a detected tempo automatically controls a flow of sheet music displayed on said display (11).

5. Electronic music stand (10) according to claim 1, characterized in that it further compromises:
means for manually controlling a flow of sheet music (18) displayed on said display (11).

6. Electronic music stand (10) according to claim 1, characterized in that it further compromises:
an electronic conducting baton (70) providing signals in response to movements of said electronic conducting baton (70) for controlling a flow of sheet music displayed on said display (11).

7. Electronic music stand (10) according to claim 1, characterized in that it further compromises:
means for detecting movements of a conducting baton (20) providing signals in response to movements of said conducting baton for controlling a flow of sheet music displayed on said display (11).

8. Electronic music stand (10) according to claim 4, characterized in that a control of a flow of sheet music is transmittable music via the communication port (13) to one or more of the connected other electronic music stands (50) thus remotely controlling the flow of sheet music displayed on a display (11) of said connected other electronic music stand (50).

9. Electronic music stand (10) according to claim 1, characterized in that it further compromises:
a video camera (29) for recording images of the user acting as conductor, said images being transmittable via the communication port (13) to one or more of the connected slave electronic music stands (50).

10. Electronic music stand (10) according to claim 1, characterized in that the display (11) is a touch-sensitive panel.

11. Electronic music stand (10) according to claim 1, characterized in that the electronic music stand (10) serves as master electronic music stand (10) and the other electronic music stand (50) serves as slave electronic music stand (50).

12. A conductor centric electronic music stand system (1) comprising:
an electronic music stand (10), having
a display (11) for displaying an interactive user interface showing sheet music and annotations,
a storage medium (12) for storing sheet music and annotations,
a communication port (13) for connecting at least one other electronic music stand (50),
wherein:
the electronic music stand (10) provides the user the possibility to:
annotate and/or change the sheet music via the interactive user interface (100);
transmit said annotations and/or changes to the sheet music via the communication port (13) to one or more of the connected other electronic music stands (50);
save said annotations and/or changes to the sheet music onto the storage medium (12);
retrieve said saved annotations and/or changes to the sheet music from the storage medium (12)
said electronic music stand (10) serving as master electronic music stand (10); and
one or more electronic music stands (50) serving as slave electronic music stands (50) comprising:
a display (51) for displaying an interactive user interface (100) showing sheet music and annotations;
a communication port (53) for connecting the one or more slave electronic music stands (50) with the Master electronic music stand (10);
characterized in that the conductor centric electronic music stand system (1) is configured to:
connect said slave electronic music stands (50) with the master electronic music stand (10);
enable a transmission of annotations and/or changes to the sheet music between the master electronic music stand (10) and slave electronic music stands (50);
enable the master electronic music stand (10) to transmit sheet music retrieved from its storage medium (12) to one or more slave electronic music stands (50).

13. A conductor centric electronic music stand system (1) according to claim 12, characterized in that the master electronic music stand (10) is connected with the one or more slave electronic music stands (50) by a wireless connection, preferably a standard IEEE 802.11 Wireless LAN connection.

14. A conductor centric electronic music stand system (1) according to claim 12, characterized in that the master electronic music stand (10) is connected with the one or more slave electronic music stands (50) with a wired connection, preferably an Ethernet connection.

15. A conductor centric electronic music stand system (1) according to claim 14, characterized in that the master electronic music stand (10) and/or the one or more slave electronic music stands (50) are powered by said wired connection, preferably using the power over Ethernet (PoE) standard.

16. Interactive user interface (100) for use in an electronic music stand (10, 50), said interactive user interface (100) comprising:
an area for displaying sheet music;
means for changing and/or annotating said sheet music;
means for interacting with a storage medium (12);
characterized in that:
said area for displaying sheet music is capable of simultaneously displaying a plurality of music scores (103) corresponding to different instruments;
said means for interacting with a storage medium (12) allow saving/retrieving of sheet music and of changes and annotations (101) to/from said storage medium (12);
said means for changing and/or annotating said sheet music provide the possibility of simultaneously changing and/or annotating a plurality of music scores;
said interactive user interface (100) further comprises:
a video window (111) for displaying images received/broadcast by said electronic music stand (10, 50);
means for initiating a transfer of sheet music and of changes and/or annotations (101) of the sheet music made to other electronic music stands (10, 50);
means for initiating displaying of received sheet music and of changes and annotations (101) of the sheet music from other electronic music stands (10, 50).

17. Interactive user interface (100) according to claim 16, characterized in that the interface is optimized for being displayed on a touch-sensitive panel.

18. Interactive user interface (100) according to claim 16,
characterized in that the interface has:
an orchestra mode of operation; and
a solo mode of operation,
wherein said orchestra mode of operation is optimized for use in a conductor centric electronic music stand system (1) according to one of the claims 12-15 and said solo mode of operation is optimized to be used on a disconnected electronic music stand (10, 50) for solo rehearsals or music composition.

19. Computer-readable storage medium containing a set of instructions (SI) that cause a computer with:
a display (11) for displaying an interactive user interface (IOO),
a storage medium (12), and
a communication port (13) to carry out the following functions:
load a plurality of music scores corresponding to different instruments and accompanying annotations and/or changes from a storage medium (12);
control the interactive user interface (100) to simultaneously display a plurality of music scores (103) corresponding to different instruments;
control the communication port (13) to transmit sheet music and changes and/or annotations of the sheet music made to other computers;
control the interactive user interface to display sheet music and of changes and/or annotations of the sheet music received through the communication port (13) from other computers;
allow a user of the interactive user interface to annotate and/or change sheet music displayed on it;
allow a user of the interactive user interface to save said annotations and/or changes to the sheet music onto the storage medium (12).
